(19) United States
(12) Patent Application Publication
(10) Pub. No.: US 2025/0218147 A1
(43) Pub. Date: Jul. 3, 2025

(54) Background Segmentation System

(71) Applicant: Intel Corporation, Santa Clara, CA (US)

(72) Inventors: Cornelius BUERKLE, Karlsruhe (DE); Fabian OBORIL, Karlsruhe (DE)

(21) Appl. No.: 18/961,499

(22) Filed: Nov. 27, 2024

(30) Foreign Application Priority Data
Dec. 28, 2023 (DE) 10 2023 136 757.9

(51) Int. Cl. G06V 10/26; G06V 10/764; G06V 10/98

(52) U.S. Cl. CPC G06V 10/26; G06V 10/764; G06V 10/993

(57) ABSTRACT

A system includes a processor configured to determine a first image of a first capture area including one first image element associated with first image element coding information classified as erroneous; determine a second image of a second capture area, the first capture area and the second capture area overlapping in an overlap area; determine a second image element spatially corresponding to the first image element in the second image, wherein the first image element and the second image element represent a part of the overlap area; determine substitute image element coding information for the first image element of the first image using second image element coding information associated with the second image element of the second image that is not classified as erroneous; and associate the determined substitute image element coding information with the first image element of the first image to obtain a first substitute image.

### CROSS-REFERENCE TO RELATED APPLICATIONS

This application claims priority to German patent application DE 10 2023 136 757.9, filed on Dec. 28, 2023, the entire contents of which are incorporated herein by reference.

### TECHNICAL AREA

Aspects of the disclosure relate to a system and in particular a system for background segmentation.

### BACKGROUND

In a conventional system for background segmentation, erroneous sensor data (or data generated based on erroneous sensor data) can have the result that errors occur in the background segmentation. If these results are used to control robots or other systems, for example, erroneous movements can be generated in this way.

### BRIEF DESCRIPTION OF THE FIGURES

Aspects of the disclosure are shown in the figures and will be explained in more detail hereinafter. In the figures:

FIG. 1 shows a schematic representation of a control system for a capture area;

FIG. 2 shows an example of a depth image having poor quality;

FIG. 3 shows an example of a control system having steps for a background segmentation according to aspects of the disclosure;

FIG. 4A, FIG. 4B, and FIG. 4C show an example of a background segmentation according to aspects of the disclosure;

FIG. 5 shows an example of a projection of a distribution of measured values according to aspects of the disclosure;

FIG. 6 shows an example of a determination of dynamic pixels according to aspects of the disclosure;

FIG. 7 shows an example of a system according to aspects of the disclosure;

FIG. 8 shows an example of a system according to aspects of the disclosure;

FIG. 9 shows steps which a system according to aspects of the disclosure is configured to carry out;

FIG. 10A shows further steps which a system according to aspects of the disclosure is configured to carry out;

FIG. 10B is a continuation of FIG. 10A;

FIG. 10C is a continuation of FIG. 10B;

FIG. 10D is a continuation of FIG. 10C;

FIG. 11 shows steps which a system according to aspects of the disclosure is configured to carry out;

FIG. 12A shows further steps which a system according to aspects of the disclosure is configured to carry out;

FIG. 12B is a continuation of FIG. 12A;

FIG. 12C is a continuation of FIG. 12B;

FIG. 12D is a continuation of FIG. 12C;

FIG. 13 shows an example of the application of aspects of the disclosure.

### SPECIFICATION

In the following comprehensive specification, reference is made to the appended drawings, which form part of this specification and in which aspects of the disclosure are shown for illustration. In this regard, directional terminology such as “above”, “below”, “in front”, “behind”, “front”, “rear”, etc. is used with reference to the orientation of the described figure(s). Since components of aspects of the disclosure can be positioned in a number of different orientations, the directional terminology is used for illustration and is in no way restrictive. It is apparent that other aspects of the disclosure can be used and structural or logical changes can be performed without deviating from the scope of protection. It is apparent that the features of the various aspects of the disclosure described herein can be combined with one another, if not specifically indicated otherwise. The following detailed specification is therefore not to be interpreted in a restrictive sense, and the scope of protection is defined by the appended claims.

In the scope of this specification, the terms “connected”, “attached”, and “coupled” are used to describe both a direct and an indirect connection, a direct or indirect attachment, and a direct or indirect coupling. In the figures, identical or similar elements are provided with identical reference signs where appropriate.

According to aspects of the present disclosure, in an image which was captured by a first imaging device, or in an image which was generated based on an image captured by a first imaging device, image element coding information (that is classified as erroneous) is replaced by spatially corresponding image element coding information (that is not classified as erroneous) from an image captured by a second imaging device, or from an image that was generated based on an image captured by a second imaging device. Alternatively thereto, based on the fact that an image captured by a first imaging device or an image generated based on an image captured by a first imaging device, contains image element coding information classified as erroneous, and an image captured by a second imaging device or an image generated based on an image captured by a second imaging device contains spatially corresponding image element coding information classified as erroneous, the respective image element coding information can be discarded. The underlying technology according to aspects of the disclosure can also be referred to as an early fusion approach, since image element coding information classified as erroneous is already replaced or discarded on the level of the respective imaging device (for example, by image element coding information of another imaging device that is not classified as erroneous image element coding information). The reliability of a background segmentation based on the images can thus be increased.

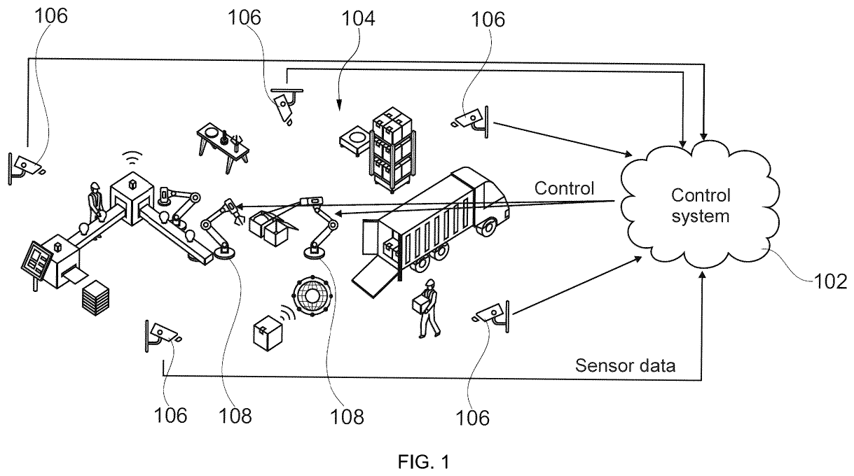

FIG. 1 shows a schematic representation of a control system 102 for a capture area 104. The control system 102 can be configured to receive sensor data of various imaging devices (such as cameras) 106. The control system 102 can be configured to generate control commands for actuators (such as robots) 108 based on the received sensor data and transmit these commands thereto.

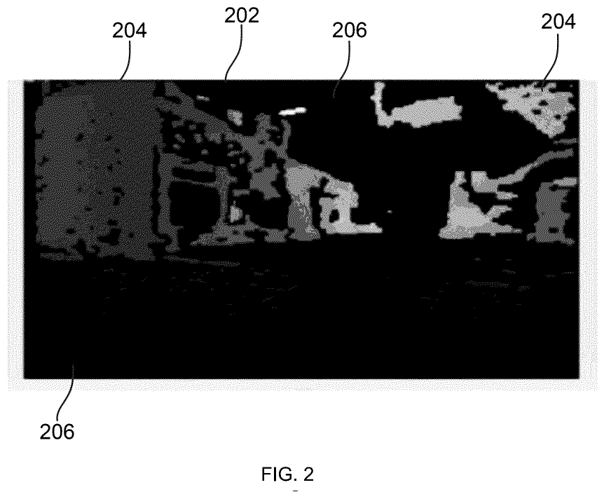

FIG. 2 shows an example of a depth image 202 having poor quality. The depth image 202 is an example of sensor data of an imaging device 106 (a depth camera here). The depth image 202 has areas having valid image data 204 and areas having invalid image data 206. In addition, both valid and invalid image data can be provided with probability information, which relates to validity or invalidity (on the basis of pixels, partial images, or images). This probability information can also express the quality of the image information. Areas having invalid image data 206 can arise, for example, due to strong dazzling effects or reflections in an image scene (for example, captured by means of the imaging device 106). In areas having invalid image data 206, the imaging device 106 is referred to as blind (i.e. the data can be classified as erroneous). Areas having invalid image data 206 can have, for example, NAN (“not a number”), infinite, or predefined (for example, sensor-specific) values as the value. Invalid image data, if they have not previously been corrected or replaced, for example, can result in the generation of erroneous commands for actuators 108.

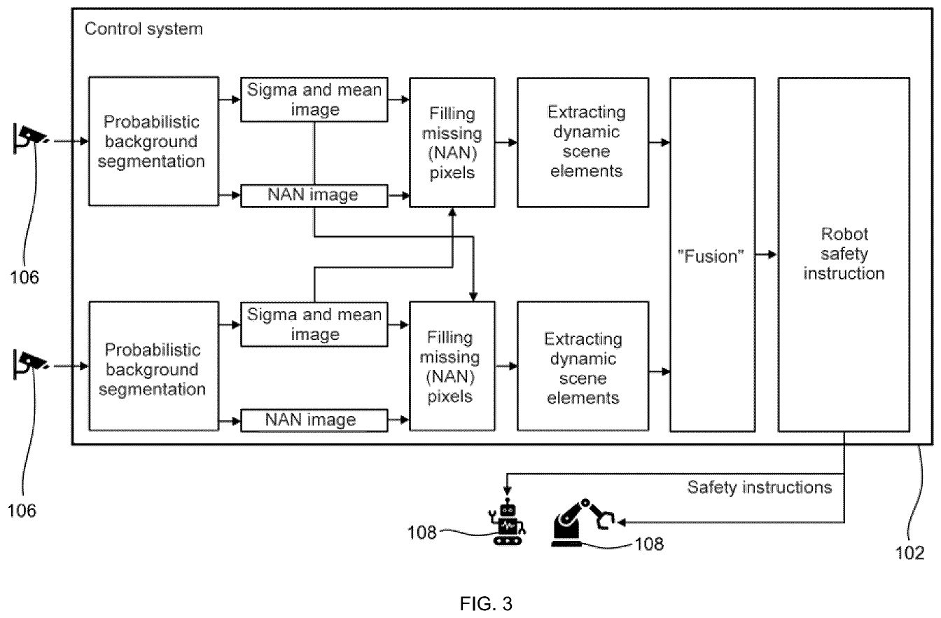

FIG. 3 shows an example of a control system 102 having steps for a background segmentation according to aspects of the disclosure. As shown in FIG. 3, imaging devices 106 (for example, a first imaging device and a second imaging device) can transmit sensor data to the control system 102. The control system 102 (for example, a processor thereof) can be configured to carry out a probabilistic background segmentation (for example, in each case) on the (for example, on the respective) sensor data of the imaging devices 106. For this purpose, the control system 102 can be configured to generate a sigma image (for example, a first sigma image and/or a second sigma image) and a mean image (for example, a first mean image and/or a second mean image, for example, a first combined mean and sigma image and/or a second combined mean and sigma image) from the respective sensor data (for example, from a (chronological) sequence of captured sensor data). Further, the control system 102 can be configured to generate a NAN image (for example, a first NAN image and/or a second NAN image) from the respective sensor data (for example, from the (chronological) sequence of captured sensor data). In this case, the control system 102 can be configured to assign image element coding information to image elements in the respective NAN image, which indicate that in the associated sigma image and/or mean image (for example, in the associated combined mean and sigma image), image element coding information which is classified as erroneous (for example, which has an invalid value; for example, which is/was generated based on an invalid value) is assigned to an image element. Further, the control system 102 can be configured, based on the respective NAN image, to assign (for example, thus to replace) image element coding information of the other mean image and/or the other sigma image (or the other combined mean and sigma image) to those image elements of the associated sigma image and/or mean image (for example, of the associated combined mean and sigma image) which are classified as erroneous at a spatially corresponding point that is not classified as erroneous, in order to obtain an updated sigma image and/or mean image (for example, an updated combined mean and sigma image). That is to say, according to aspects of the present disclosure, image element coding information in an image of an imaging device can be replaced (for example, thus updated) based on spatially corresponding image element coding information in an image of another imaging device, so that image element coding information classified as erroneous can be replaced in a very early stage of the background segmentation. Further, the control system 102 can be configured, based on the updated sigma image and/or the updated mean image (for example, or the updated combined mean and sigma image), to extract dynamic scene elements in a further image of the respective imaging device, to fuse the extracted dynamic scene elements, and to generate control commands (for example, robot safety commands) based thereon. The control system 102 can further be configured to transmit the generated control commands to an actuator (for example, a robot) 108.

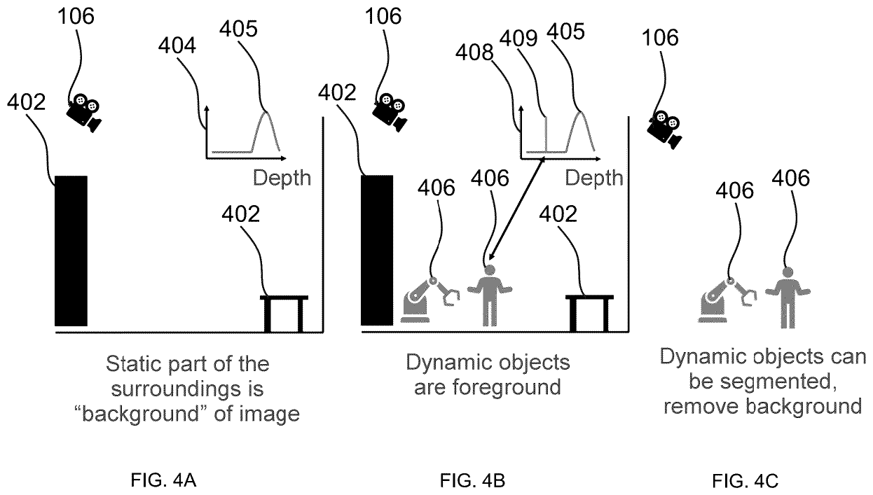

FIG. 4A, FIG. 4B, and FIG. 4C show an example of a background segmentation according to aspects of the disclosure. FIG. 4A shows a scene captured by means of an imaging device 106, which includes static elements 402, but no dynamic elements. Further, FIG. 4A shows a histogram 404, which represents a number of pixels as a function of the distance of the pixels to the imaging device 106. A peak 405, which represents the static elements 402, is shown in the histogram 404. In FIG. 4B, dynamic elements 406 have been added to the static elements 402. In this case, FIG. 4B shows a histogram 408, in which in addition to the peak 405, which represents the static elements 402, an outlier line 409 is shown, which represents the dynamic elements 406. As shown in FIG. 4C, the dynamic elements 406 can be segmented (i.e. the static elements 402 can be removed) based on a comparison of the histograms 404 and 408.

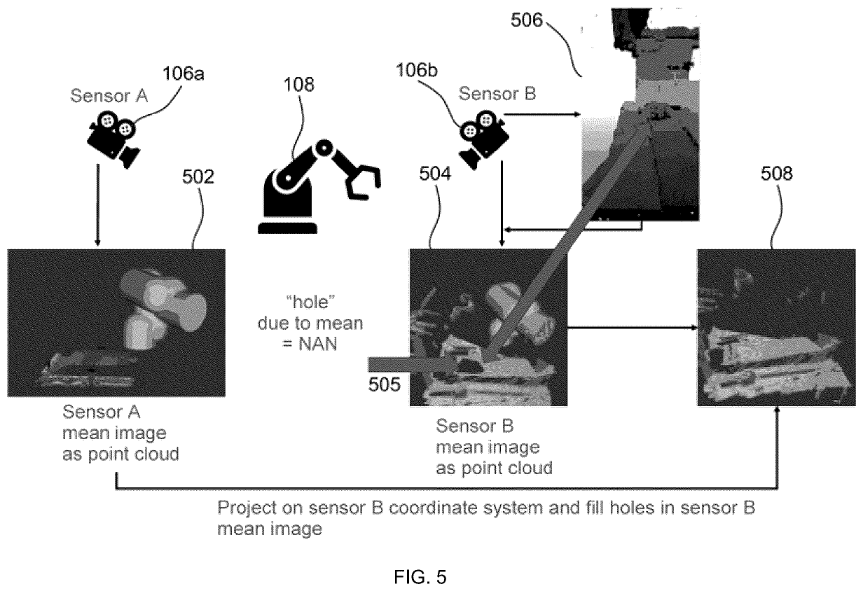

FIG. 5 shows an example of a projection of a distribution of measured values according to aspects of the disclosure. FIG. 5 shows a first mean image 502 as a point cloud, which was captured by means of a first imaging device 106a in a first capture area, and a second mean image 504 as a point cloud, which was captured by means of a second imaging device 106b in a second capture area. The second mean image 504 includes an area without valid measured values 505 (i.e. a hole). Since the first capture area and the second capture area overlap in the area without valid measured values 505, the first mean image 502 can be projected onto the second mean image 504, and the area without valid measured values 505 in the second mean image 504 can be filled by spatially corresponding information from the first mean image 502 in order to obtain substitute mean image 508, which does not include an area without valid measured values. Formally, this can be represented, for example, as

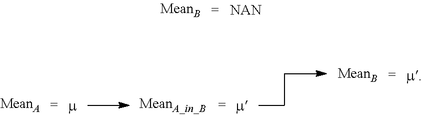

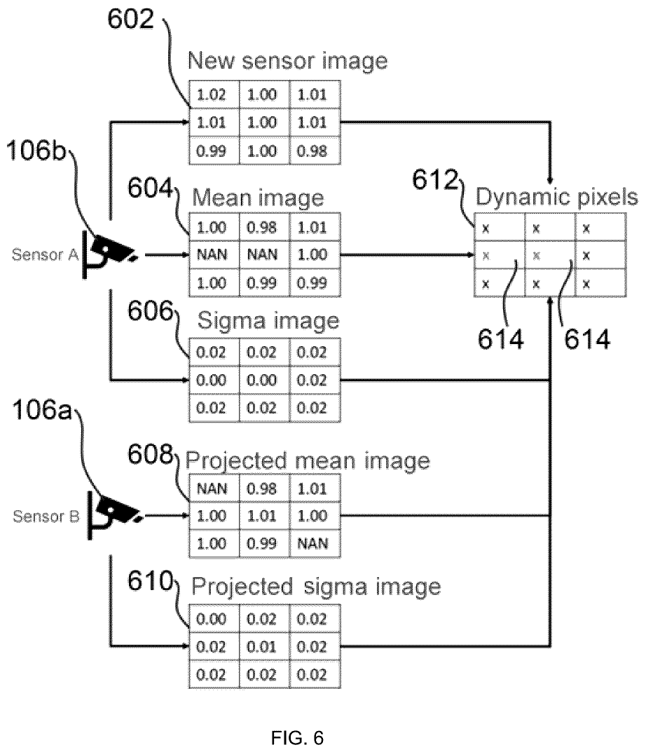

FIG. 6 is an example of a determination of dynamic pixels according to aspects of the disclosure. FIG. 6 represents a new first sensor image 602 captured by means of a first imaging device 106a, as well as a first mean image 604 and a first sigma image 606, which are assigned to the first imaging device 106a. In the mean image 604, image element coding information having the value NAN is assigned to each of two image elements. An outlier analysis based on the new first sensor image 602, the mean image 604, and the sigma image 606 would result, for the image elements to which NAN is assigned as image element coding information, in no dynamic pixels at the corresponding points. FIG. 6 further shows a second mean image 608 and a second sigma image 610, which are assigned to the second imaging device 106b and which are projected in an assigned manner in the first mean image 604 and the first sigma image 606. An outlier analysis based on the new first sensor image 602, the projected second mean image 608, and the projected second sigma image 610 results, for the image elements to each of which image element coding information having the value NAN is assigned in the mean image 604, in a dynamic pixel 614 in each case.

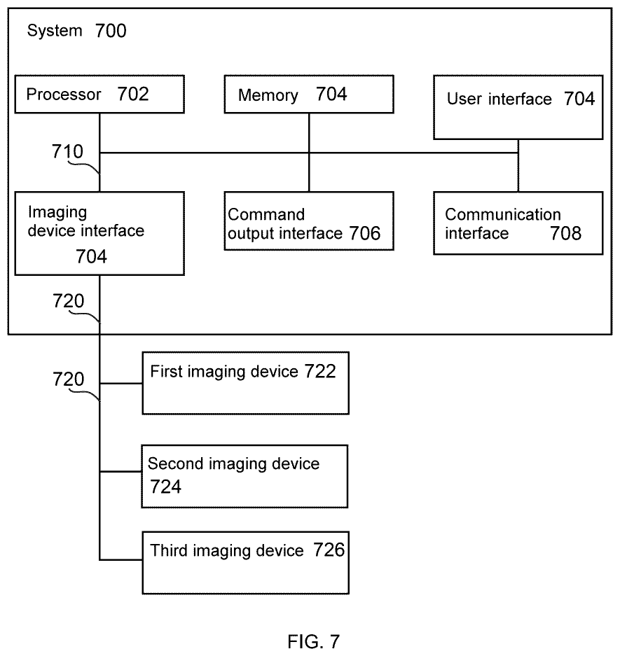

FIG. 7 is an example of a system 700 according to aspects of the disclosure. As shown in FIG. 7, a system 700 (for example, a system 700 for background segmentation) according to aspects of the disclosure can include: a processor 702, a memory 704, a user interface 704, an imaging device interface 704, a command output interface 706, and/or a communication interface 708. The processor 702, the memory 704, the user interface 704, the imaging device interface 704, the command output interface 706, and/or the communication interface 708 can be connected to one another by means of a connection bus 710. Further, the imaging device interface 704 (and therefore, for example, the system 700) can be connected by means of an imaging connection 720 to a first imaging device 722 (external to the system 700), a second imaging device 724 (external to the system 700), and/or a third imaging device 726 (external to the system 700). For example, further imaging devices (external to the system 700) can be connected to the system 700 by means of the imaging connection 720.

The system 700 (for example, the processor 702 thereof) can receive inputs (for example, control input) from a user and/or transmit outputs to the user by means of the user interface 704.

The system 700 (for example, the processor 702 thereof) can generate control commands and can transmit the generated control commands by means of the command output interface 706 to devices (external to the system 700).

The system 700 (for example, the processor 702 thereof) can communicate by means of the communication interface 708 with an external communication network.

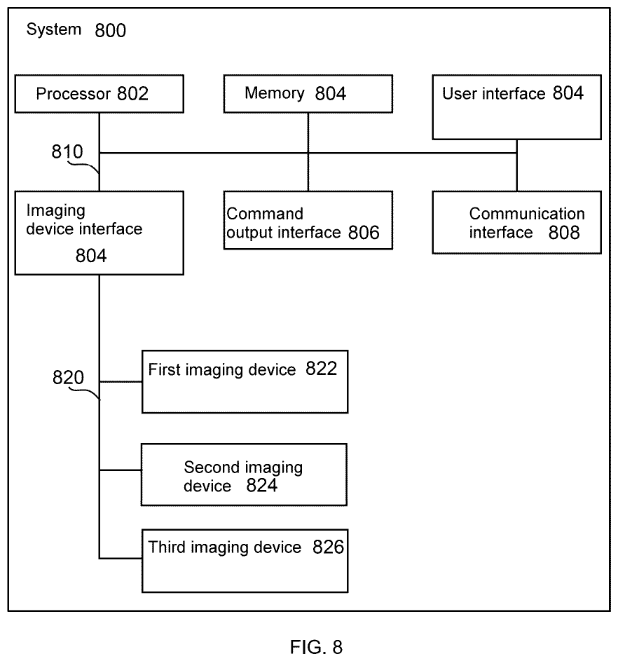

FIG. 8 is an example of a system 800 according to aspects of the disclosure. As shown in FIG. 8, a system 800 (for example, a system 800 for background segmentation) according to aspects of the disclosure can include: a processor 802, a memory 804, a user interface 804, an imaging device interface 804, a command output interface 806, a communication interface 808, a first imaging device 822, a second imaging device 824, and/or a third imaging device 826. The processor 802, the memory 804, the user interface 804, the imaging device interface 804, the command output interface 806, and/or the communication interface 808 can be connected to one another by means of a connection bus 810. Further, the imaging device interface 804 (and therefore the system 800) can be connected by means of an imaging connection 820 to the first imaging device 822, the second imaging device 824, and/or the third imaging device 826. For example, further imaging devices can be connected to the system 800 by means of the imaging connection 820.

The system 800 (for example, the processor 802 thereof) can receive inputs (for example, control input) from a user and/or transmit outputs to the user by means of the user interface 804.

The system 800 (for example, the processor 802 thereof) can generate control commands and can transmit the generated control commands by means of the command output interface 806 to devices (external to the system 800).

The system 800 (for example, the processor 802 thereof) can communicate by means of the communication interface 808 with an external communication network.

With reference to FIG. 7 and FIG. 8, the imaging devices 722, 724, 726, 822, 824, 826 (or the further imaging devices) can also (for example, in a mixed manner) be internal (i.e. contained therein) and/or external to the system 700 or to the system 800. The system 700 and the system 800 are not restricted in any way in this case.

With reference to FIG. 7 and FIG. 8, the imaging devices 722, 724, 726, 822, 824, 826 (or the further imaging devices) can be arranged in a spatially fixed manner. Alternatively, all or some of the imaging devices 722, 724, 726, 822, 824, 826 (or the further imaging devices) can be arranged movably in space.

The first imaging device 722, 822 can be a first camera, a first LiDAR camera, or a first depth camera; and/or the second imaging device 724, 824 can be a second camera, a second LiDAR camera, or a second depth camera. Further, the third imaging device 726, 826 (and also, for example, each further imaging device) can also be a first camera, a first LiDAR camera, or a first depth camera.

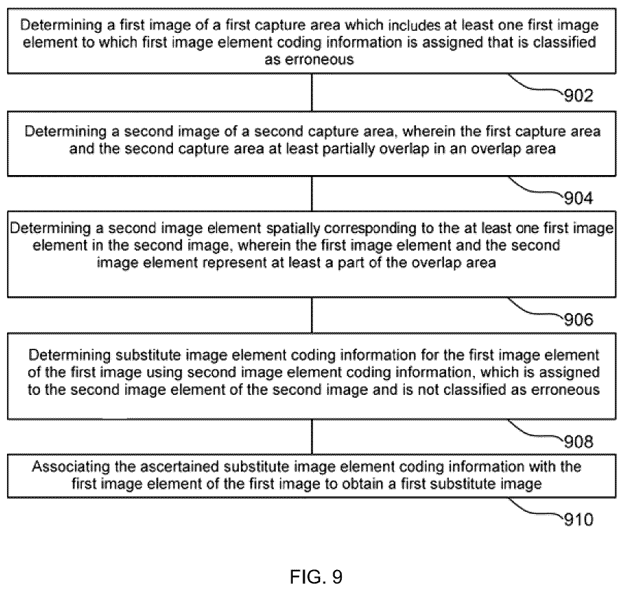

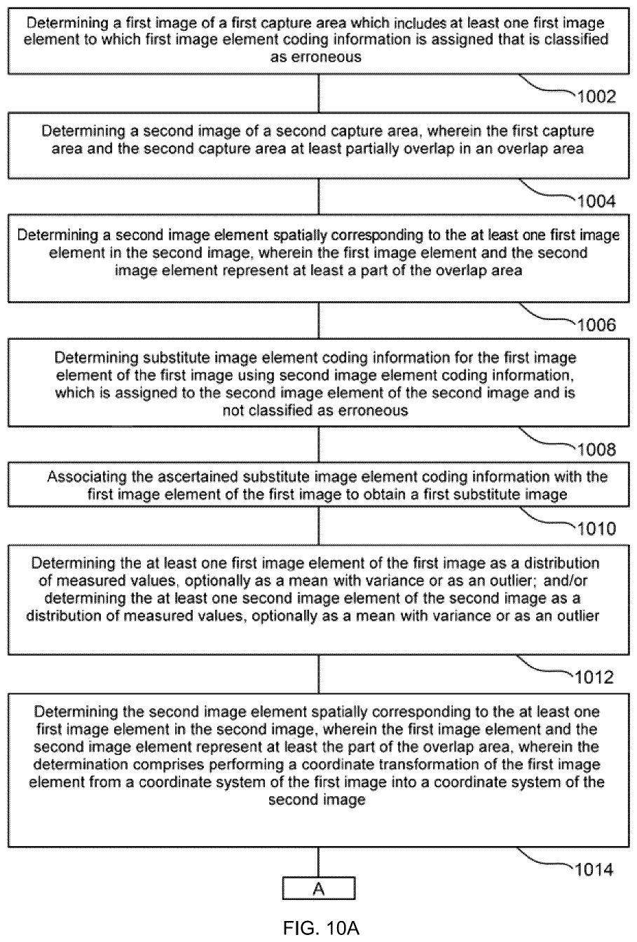

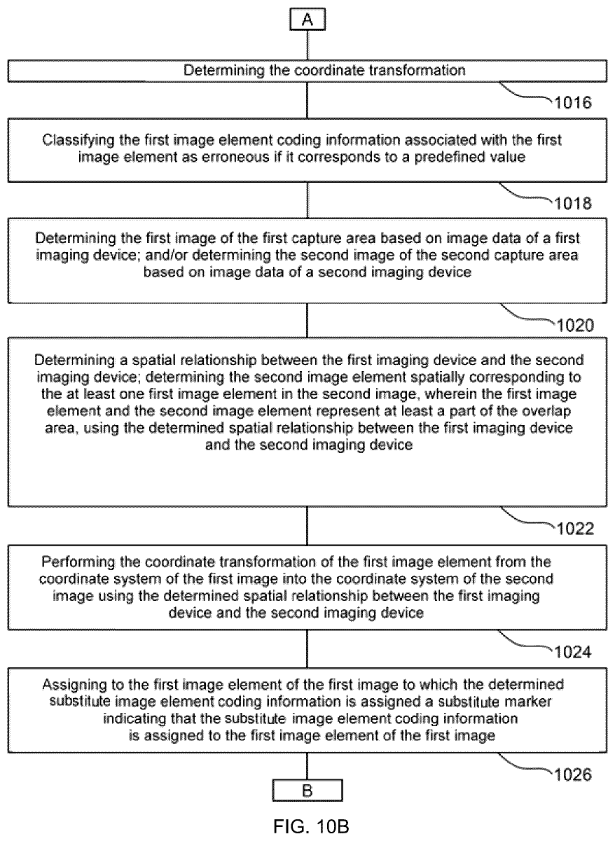

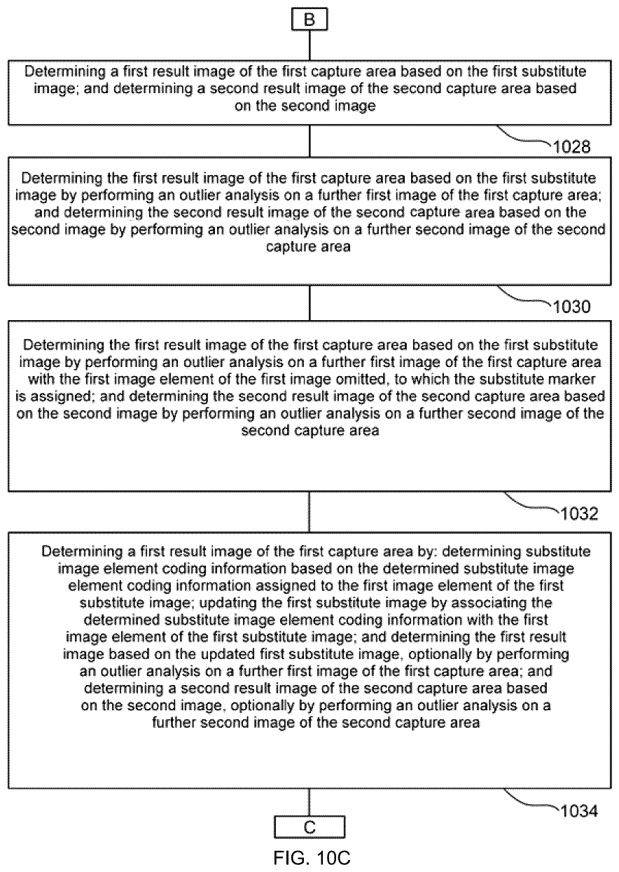

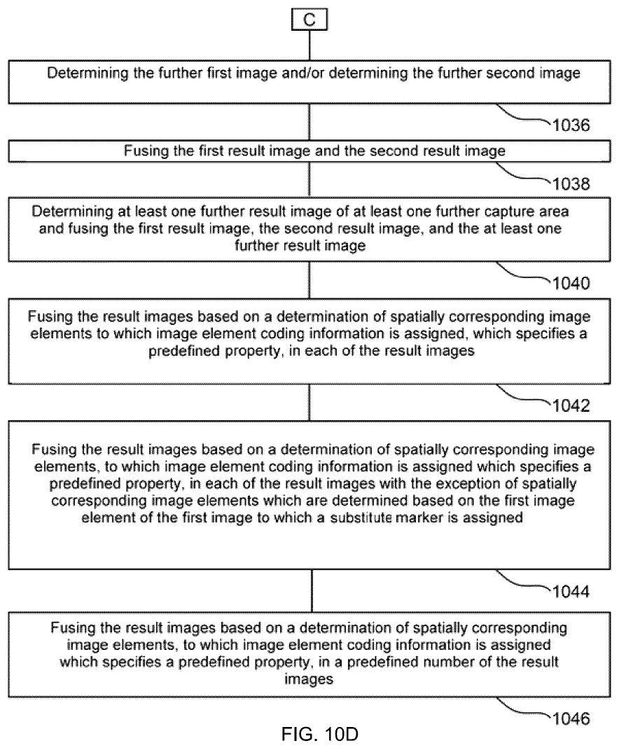

FIG. 9 shows steps which a system 700 and/or a system 800 according to aspects of the disclosure is configured to carry out. FIG. 10A shows further steps which a system 700 and/or a system 800 according to aspects of the disclosure is configured to carry out. FIG. 10B is a continuation of FIG. 10A. FIG. 10C is a continuation of FIG. 10B. FIG. 10D is a continuation of FIG. 10C.

As shown in FIG. 9, the processor 702 of the system 700 and/or the processor 802 of the system 800 can be configured to: determine (902) a first image of a first capture area including at least one first image element associated with first image element coding information classified as erroneous; determine (904) a second image of a second capture area, wherein the first capture area and the second capture area are at least partially overlapping in an overlap area; determine (906) a second image element spatially corresponding to the at least one first image element in the second image, wherein the first image element and the second image element represent at least a part of the overlap area; determine (908) substitute image element coding information for the first image element of the first image using second image element coding information associated with the second image element of the second image that is not classified as erroneous; and associate (910) the determined substitute image element coding information with the first image element of the first image to obtain a first substitute image.

The first image element can be, for example, a first pixel, and/or the second image element can be, for example, a second pixel.

The image element coding information (for example, the first and/or the second image element coding information) can be any coding information associated with an image element, for example, a value, a numeric value, an integer, a word, a floating-point value, or the like.

As shown in FIG. 10A, FIG. 10B, FIG. 10C, and FIG. 10D, the processor 702 of the system 700 and/or the processor 802 of the system 800 can initially be configured as shown in FIG. 9, i.e. to: determine (1002) a first image of a first capture area including at least one first image element associated with first image element coding information classified as erroneous; determine (1004) a second image of a second capture area, wherein the first capture area and the second capture area are at least partially overlapping in an overlap area; determine (1006) a second image element spatially corresponding to the at least one first image element in the second image, wherein the first image element and the second image element represent at least a part of the overlap area; determine (1008) substitute image element coding information for the first image element of the first image using second image element coding information associated with the second image element of the second image that is not classified as erroneous; and associate (1010) the determined substitute image element coding information with the first image element of the first image to obtain a first substitute image.

The first image can be a first three-dimensional image (for example, an image which specifies respective distance information for each image element/pixel) which can optionally include distance information; and/or the second image can be a second three-dimensional image (for example, an image which specifies respective distance information for each image element/pixel) which can optionally include distance information.

The first image can be a 3D point cloud or a depth image; and/or the second image can be a 3D point cloud or a depth image.

Further, the processor 702 of the system 700 and/or the processor 802 of the system 800 can be configured to calculate the first image from one or more images/data captured (for example, in chronological sequence) by means of a first imaging device 722; and/or to calculate the second image from one or more images/data captured (for example, in chronological sequence) by means of a second imaging device 724.

Further, the processor 702 of the system 700 and/or the processor 802 of the system 800 can be configured to: determine (1012) the at least one first image element of the first image as a distribution of measured values, optionally as a mean with variance or as an outlier (for example, from one or more images/data captured (for example, in chronological sequence) by means of a first imaging device 722); and/or determine (1012) the at least one second image element of the second image as a distribution of measured values, optionally as a mean with variance or as an outlier (for example, from one or more images/data captured (for example, in chronological sequence) by means of a second imaging device 724).

Further, the processor 702 of the system 700 and/or the processor 802 of the system 800 can be configured to: determine (1014) the second image element spatially corresponding to the at least one first image element in the second image, the first image element and the second image element representing at least the part of the overlap area, wherein the determining includes performing a coordinate transformation of the first image element from a coordinate system of the first image to a coordinate system of the second image.

Further, the processor 702 of the system 700 and/or the processor 802 of the system 800 can be configured to: determine (1016) the coordinate transformation.

Further, the processor 702 of the system 700 and/or the processor 802 of the system 800 can be configured to: classify (1018) the first image element coding information associated with the first image element as erroneous if it corresponds to a predefined value (for example, NAN, for example, infinite, for example, a predefined number (for example, specific for a respective imaging device)).

Further, the processor 702 of the system 700 and/or the processor 802 of the system 800 can be configured to: determine (1020) the first image of the first capture area based on image data from a first imaging device 722, 822; and/or determine (1020) the second image of the second capture area based on image data from a second imaging device 724, 824.

Further, the processor 702 of the system 700 and/or the processor 802 of the system 800 can be configured to: determine (1022) a spatial relationship between the first imaging device 722, 822 and the second imaging device 724, 824; and determine (1022) the second image element spatially corresponding to the at least one first image element in the second image, wherein the first image element and the second image element represent at least a part of the overlap area using the determined spatial relationship between the first imaging device 722, 822 and the second imaging device 724, 824.

Performing (1014) the coordinate transformation of the first image element from the coordinate system of the first image to the coordinate system of the second image can be performed (1024) using the determined spatial relationship between the first imaging device 722, 822 and the second imaging device 724, 824 (i.e. the processor 702 of the system 700 and/or the processor 802 of the system 800 can be configured for this purpose).

Further, the processor 702 of the system 700 and/or the processor 802 of the system 800 can be configured to: assign (1026) to the first image element of the first image to which the substitute image element coding information is assigned a substitute marker indicating that the determined substitute image element coding information is assigned to the first image element of the first image.

Further, the processor 702 of the system 700 and/or the processor 802 of the system 800 can be configured to: determine (1028) a first result image of the first capture area based on the first substitute image; and determine (1028) a second result image of the second capture area based on the second image.

Further, the processor 702 of the system 700 and/or the processor 802 of the system 800 can be configured to: determine (1030) the first result image of the first capture area based on the first substitute image by performing an outlier analysis on a further first image (for example, an image newly captured by means of the first imaging device 722, which was not used, for example, to calculate the first image) of the first capture area; and determine (1030) the second result image of the second capture area based on the second image by performing an outlier analysis on a further second image (for example, an image newly captured by means of the second imaging device 724, which was not used, for example, to calculate the second image) of the second capture area.

Further, the processor 702 of the system 700 and/or the processor 802 of the system 800 can be configured to: determine (1032) the first result image of the first capture area based on the first substitute image by performing an outlier analysis on a further first image of the first capture area omitting the first image element of the first image with which the substitute marker is associated; and determine (1032) the second result image of the second capture area based on the second image by performing an outlier analysis on a further second image of the second capture area.

Further, the processor 702 of the system 700 and/or the processor 802 of the system 800 can be configured to: determine (1034) a first result image (for example, an image which represents a result of a background segmentation) of the first capture area by: determining (1034) substitute image element coding information based on the determined substitute image element coding information associated with the first image element of the first substitute image; updating (1034) the first substitute image by associating the determined substitute image element coding information with the first image element of the first substitute image; and determining (1034) the first result image based on the updated first substitute image, optionally by performing an outlier analysis on a further first image of the first capture area; and determine (1034) a second result image of the second capture area based on the second image, optionally by performing an outlier analysis on a further second image of the second capture area.

Further, the processor 702 of the system 700 and/or the processor 802 of the system 800 can be configured to: determine (1036) the further first image; and/or determine (1036) the further second image.

The further first image can be a further first three-dimensional image, which can optionally include distance information; and/or the further second image can be a further second three-dimensional image, which can optionally include distance information.

The further first image can be a 3D point cloud or a depth image; and/or the further second image can be a 3D point cloud or a depth image.

Further, the processor 702 of the system 700 and/or the processor 802 of the system 800 can be configured to: fuse the first result image and the second result image.

Further, the processor 702 of the system 700 and/or the processor 802 of the system 800 can be configured to: determine at least one further result image of at least one further capture area; and to fuse the first result image, the second result image, and the at least one further result image.

Further, the processor 702 of the system 700 and/or the processor 802 of the system 800 can be configured to: fuse the result images based on a determination of spatially corresponding image elements with which image element coding information is associated that specifies a predefined property in each of the result images.

Further, the processor 702 of the system 700 and/or the processor 802 of the system 800 can be configured to: fuse the result images based on a determination of spatially corresponding image elements, with which image element coding information is associated that specifies a predefined property in each of the result images with the exception of spatially corresponding image elements, which are determined based on the first image element of the first image with which a substitute marker is associated.

Further, the processor 702 of the system 700 and/or the processor 802 of the system 800 can be configured to: fuse the result images based on a determination of spatially corresponding image elements, with which image element coding information is associated that specifies a predefined property in a predefined number of the result images.

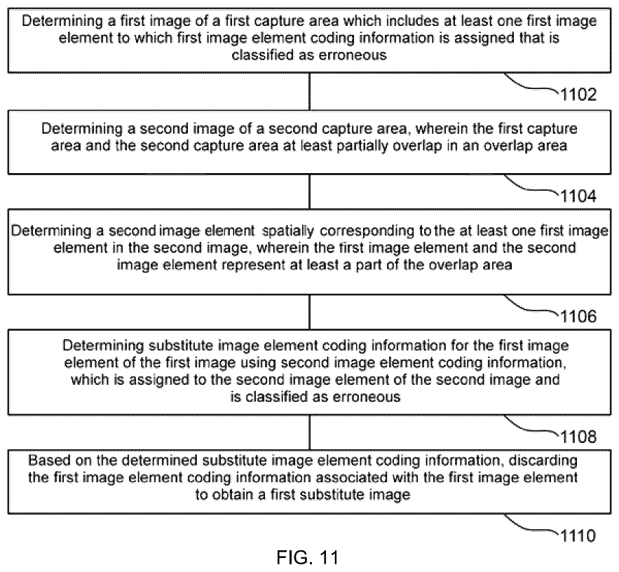

As shown in FIG. 11, the processor 702 of the system 700 and/or the processor 802 of the system 800 can be configured to: determine (1102) a first image of a first capture area including at least one first image element associated with first image element coding information classified as erroneous; determine (1104) a second image of a second capture area, wherein the first capture area and the second capture area are at least partially overlapping in an overlap area; determine (1106) a second image element spatially corresponding to the at least one first image element in the second image, wherein the first image element and the second image element represent at least a part of the overlap area; determine (1108) substitute image element coding information for the first image element of the first image using second image element coding information associated with the second image element of the second image that is classified as erroneous; and based on the determined substitute image element coding information, discard (1110) the image element coding information associated with the first image element to obtain a first substitute image.

The first image element can be, for example, a first pixel, and/or the second image element can be, for example, a second pixel.

The image element coding information (for example, the first and/or the second image element coding information) can be any coding information associated with an image element, for example, a value, a numeric value, an integer, a word, a floating-point value, or the like.

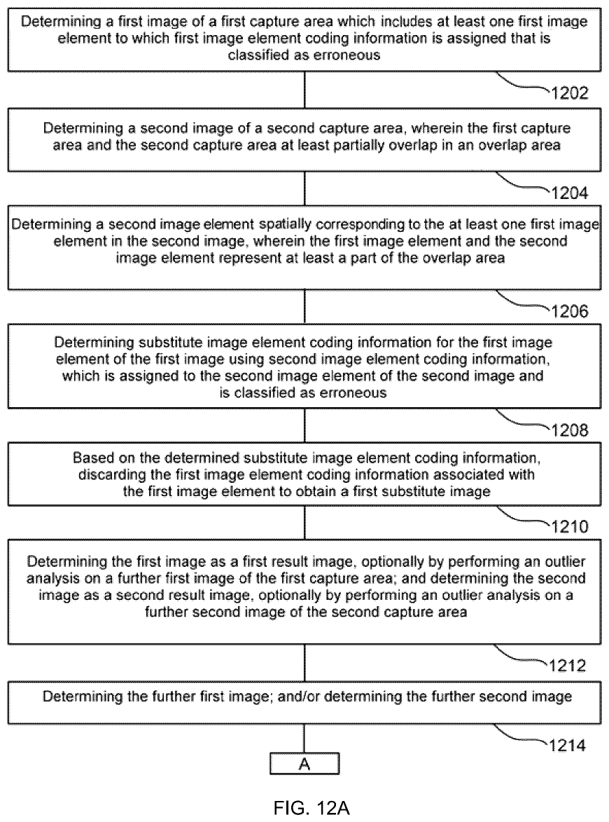

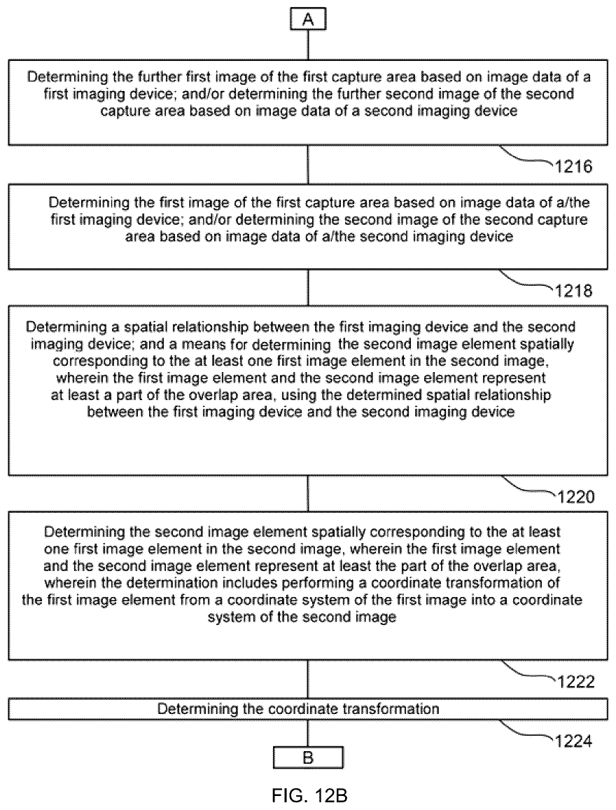

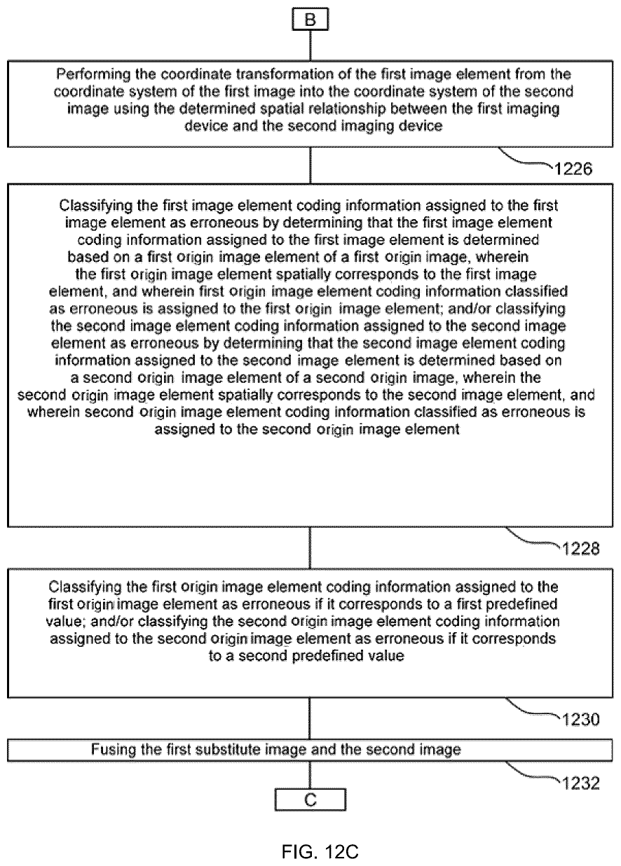

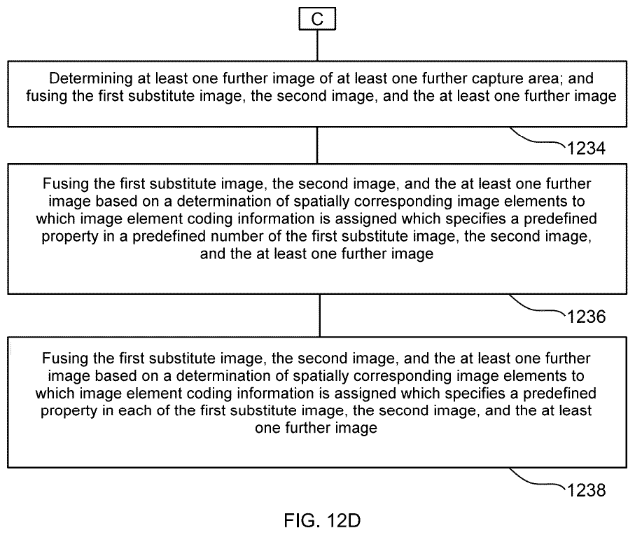

As shown in FIG. 12A, FIG. 12B, FIG. 12C, and FIG. 12D, the processor 702 of the system 700 and/or the processor 802 of the system 800 can initially be configured as shown in FIG. 11, i.e. to: determine (1202) a first image (for example, a first image which represents a result of a background segmentation) of a first capture area including at least one first image element associated with first image element coding information classified as erroneous; determine (1204) a second image (for example, a second image which represents a result of a background segmentation) of a second capture area, wherein the first capture area and the second capture area are at least partially overlapping in an overlap area; determine (1206) a second image element spatially corresponding to the at least one first image element in the second image, wherein the first image element and the second image element represent at least a part of the overlap area; determine (1208) substitute image element coding information for the first image element of the first image using second image element coding information associated with the second image element of the second image that is classified as erroneous; and based on the determined substitute image element coding information, discard (1210) the first image element coding information associated with the first image element to obtain a first substitute image.

Further, the processor 702 of the system 700 and/or the processor 802 of the system 800 can be configured to: determine (1212) the first image as a first result image (for example, as an image which represents the result of a background segmentation), optionally by performing an outlier analysis on a further first image of the first capture area; and determine (1212) the second image as a second result image (for example, as an image which represents the result of a background segmentation), optionally by performing an outlier analysis on a further second image of the second capture area.

Further, the processor 702 of the system 700 and/or the processor 802 of the system 800 can be configured to: determine (1214) the further first image; and/or determine (1214) the further second image.

The further first image can be a further first three-dimensional image, which can optionally include distance information; and/or wherein the further second image can be a further second three-dimensional image, which can optionally include distance information.

The further first image can be a 3D point cloud or a depth image; and/or the further second image can be a 3D point cloud or a depth image.

Further, the processor 702 of the system 700 and/or the processor 802 of the system 800 can be configured to: determine (1216) the further first image of the first capture area based on image data of a first imaging device 722, 822; and/or determine (1216) the further second image of the second capture area based on image data of a second imaging device 724, 824.

Further, the processor 702 of the system 700 and/or the processor 802 of the system 800 can be configured to: determine (1218) the first image of the first capture area based on image data of a/the first imaging device 722, 822; and/or determine (1218) the second image of the second capture area based on image data of a/the second imaging device 724, 824.

Further, the processor 702 of the system 700 and/or the processor 802 of the system 800 can be configured to: determine (1220) a spatial relationship between the first imaging device 722, 822 and the second imaging device 724, 824; and determine (1220) the second image element spatially corresponding to the at least one first image element in the second image, wherein the first image element and the second image element represent at least a part of the overlap area, using the determined spatial relationship between the first imaging device 722, 822 and the second imaging device 724, 824.

Further, the processor 702 of the system 700 and/or the processor 802 of the system 800 can be configured to: determine (1206) the second image element spatially corresponding to the at least one first image element in the second image, wherein the first image element and the second image element represent at least the part of the overlap area, wherein the determining (1206) includes performing (1222) of a coordinate transformation of the first image element from a coordinate system of the first image to a coordinate system of the second image.

Further, the processor 702 of the system 700 and/or the processor 802 of the system 800 can be configured to: determine (1224) the coordinate transformation.

Performing (1222) the coordinate transformation of the first image element from the coordinate system of the first image to the coordinate system of the second image can be performed using the determined spatial relationship between the first imaging device 722, 822 and the second imaging device 724, 824 (i.e. the processor 702 of the system 700 and/or the processor 802 of the system 800 can be configured for this purpose).

Further, the processor 702 of the system 700 and/or the processor 802 of the system 800 can be configured to: classify the first image element coding information associated with the first image element as erroneous by determining (1228) that the first image element coding information associated with the first image element is determined based on a first origin image element of a first origin image (i.e., for example, an image which was used to determine the first image), wherein the first origin image element corresponds spatially to the first image element, and wherein the first origin image element is associated with first origin image element coding information that is classified as erroneous; and/or classify the second image element coding information associated with the second image element as erroneous by determining (1228) that the second image element coding information associated with the second image element is determined based on a second origin image element of a second origin image (i.e., for example, an image which was used to determine the second image), wherein the second origin image element corresponds spatially to the second image element, and wherein the second origin image element is associated with second origin image element coding information that is classified as erroneous.

Further, the processor 702 of the system 700 and/or the processor 802 of the system 800 can be configured to: classify (1230) the first origin image element coding information associated with the first origin image element as erroneous if it corresponds to a first predefined value; and/or classify (1230) the second origin image element coding information associated with the second origin image element as erroneous if it corresponds to a second predefined value.

The first origin image can be a first three-dimensional origin image which can optionally include distance information; and/or the second origin image can be a second three-dimensional origin image which can optionally include distance information.

The first origin image can be a 3D point cloud or a depth image; and/or the second origin image can be a 3D point cloud or a depth image.

Further, the processor 702 of the system 700 and/or the processor 802 of the system 800 can be configured to: fuse (1232) the first substitute image and the second image.

Further, the processor 702 of the system 700 and/or the processor 802 of the system 800 can be configured to: determine (1234) at least one further image of at least one further capture area; and fuse (1234) the first substitute image, the second image, and the at least one further image.

Further, the processor 702 of the system 700 and/or the processor 802 of the system 800 can be configured to: fuse (1236) the first substitute image, the second image, and the at least one further image based on a determination of spatially corresponding image elements, with which image element coding information is associated that specifies a predefined property in a predefined number of the first substitute image, the second image, and the at least one further image.

Further, the processor 702 of the system 700 and/or the processor 802 of the system 800 can be configured to: fuse (1238) the first substitute image, the second image, and the at least one further image based on a determination of spatially corresponding image elements, with which image element coding information is associated that specifies a predefined property in each of the first substitute image, the second image, and the at least one further image.

In the meaning of aspects of the disclosure, the term “spatially corresponding” can refer, for example, to image elements of different images reproducing or mapping the same point or area in space.

Further, according to aspects of the disclosure, a non-volatile computer-readable storage medium can be provided, which stores instructions which, when executed by means of a processor, cause the processor to perform the steps, which, for example, the processor 702 of the system 700 and/or the processor 802 of the system 800 are (or can be) configured to perform as described above.

Further, according to aspects of the disclosure, a system can be provided including means for performing the steps which, for example, the processor 702 of the system 700 and/or the processor 802 of the system 800 are (or can be) configured to perform as described above.

According to aspects of the disclosure, the system 700 and/or the system 800 can be used, for example, for monitoring a working area of actuators (for example, robots). In this case, the system 700 and/or the system 800 can generate, for example, control commands in order to stop the actuators (for example, robots) if the system 700 and/or the system 800 detects dynamic image elements (for example, caused by people moving into a working area of the actuators/robots).

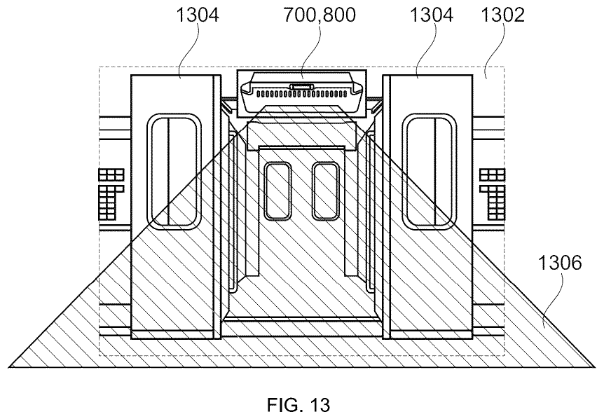

FIG. 13 shows an example of the application of aspects of the disclosure. FIG. 13 schematically shows a train 1302 having two door sections 1304. In this case, the system 700 and/or the system 800 can be used, for example, in order to monitor a monitoring area 1306 in the area of the door sections 1304 of the train 1306 for people or objects, in order to thus, for example, generate control commands to actuate the door sections 1304 (for example, to prevent closing of the door sections 1304 if people are detected in the area thereof).

Examples of aspects of the disclosure can read as follows.

Example 1: A system including: a processor configured to: determine a first image of a first capture area including at least one first image element associated with first image element coding information classified as erroneous; determine a second image of a second capture area, wherein the first capture area and the second capture area are at least partially overlapping in an overlap area; determine a second image element spatially corresponding to the at least one first image element in the second image, wherein the first image element and the second image element represent at least a part of the overlap area; determine substitute image element coding information for the first image element of the first image using second image element coding information associated with the second image element of the second image that is not classified as erroneous; and associate the determined substitute image element coding information with the first image element of the first image to obtain a first substitute image.

Example 2: The system of example 1, wherein the first image is a first three-dimensional image, optionally including distance information; and/or wherein the second image is a second three-dimensional image, optionally including distance information.

Example 3: The system of any one of examples 1 to 2, wherein the first image is a 3D point cloud or a depth image; and/or wherein the second image is a 3D point cloud or a depth image.

Example 4: The system of any one of examples 1 to 3, wherein the processor is further configured to: determine the at least one first image element of the first image as a distribution of measured values, optionally as a mean with variance or as an outlier; and/or determine the at least one second image element of the second image as a distribution of measured values, optionally as a mean with variance or as an outlier.

Example 5: The system of any one of examples 1 to 4, wherein the processor is further configured to: determine the second image element spatially corresponding to the at least one first image element in the second image, wherein the first image element and the second image element represent at least the part of the overlap area, wherein the determination includes performing a coordinate transformation of the first image element from a coordinate system of the first image to a coordinate system of the second image.

Example 6: The system of example 5, wherein the processor is further configured to: determine the coordinate transformation.

Example 7: The system of any one of examples 1 to 6, wherein the processor is further configured to: classify the first image element coding information associated with the first image element as erroneous if it corresponds to a predefined value.

Example 8: The system of any one of examples 1 to 7, wherein the processor is further configured to: determine the first image of the first capture area based on image data of a first imaging device; and/or determine the second image of the second capture area based on image data of a second imaging device.

Example 9: The system of example 8, which further includes: the first imaging device and/or the second imaging device.

Example 10: The system of any one of examples 8 to 9, wherein the processor is further configured to: determine a spatial relationship between the first imaging device and the second imaging device; determine the second image element spatially corresponding to the at least one first image element in the second image, wherein the first image element and the second image element represent at least a part of the overlap area, using the determined spatial relationship between the first imaging device and the second imaging device.

Example 11: The system of example 10, wherein: performing the coordinate transformation of the first image element from the coordinate system of the first image to the coordinate system of the second image is performed using the determined spatial relationship between the first imaging device and the second imaging device.

Example 12: The system of any one of examples 8 to 11, wherein the first imaging device is a first camera, a first LiDAR camera, or a first depth camera; and/or wherein the second imaging device is a second camera, a second LiDAR camera, or a second depth camera.

Example 13: The system of any one of examples 1 to 12, wherein the processor is further configured to: associate with the first image element of the first image with which the substitute image element coding information is associated with a substitute marker indicating that the determined substitute image element coding information is associated with the first image element of the first image.

Example 14: The system of any one of examples 1 to 13, wherein the processor is further configured to: determine a first result image of the first capture area based on the first substitute image; and determine a second result image of the second capture area based on the second image.

Example 15: The system of example 14, wherein the processor is further configured to: determine the first result image of the first capture area based on the first substitute image by performing an outlier analysis on a further first image of the first capture area; and determine the second result image of the second capture area based on the second image by performing an outlier analysis on a further second image of the second capture area.

Example 16: The system of example 13 and example 14, wherein the processor is further configured to: determine the first result image of the first capture area based on the first substitute image by performing an outlier analysis on a further first image of the first capture area omitting the first image element of the first image with which the substitute marker is associated; and determine the second result image of the second capture area based on the second image by performing an outlier analysis on a further second image of the second capture area.

Example 17: The system of any one of examples 1 to 13, wherein the processor is further configured to: determine a first result image of the first capture area by: determining substitute image element coding information based on the determined substitute image element coding information associated with the first image element of the first substitute image; updating the first substitute image by associating the determined substitute image element coding information with the first image element of the first substitute image; and determining the first result image based on the updated first substitute image, optionally by performing an outlier analysis on a further first image of the first capture area; and determine a second result image of the second capture area based on the second image, optionally by performing an outlier analysis on a further second image of the second capture area.

Example 18: The system of any one of examples 15 to 17, wherein the processor is further configured to: determine the further first image; and/or determine the further second image.

Example 19: The system of any one of examples 15 to 18, wherein the further first image is a further first three-dimensional image optionally including distance information; and/or wherein the further second image is a further second three-dimensional image optionally including distance information.

Example 20: The system of any one of examples 15 to 19, wherein the further first image is a 3D point cloud or a depth image; and/or wherein the further second image is a 3D point cloud or a depth image.

Example 21: The system of any one of examples 14 to 20, wherein the processor is further configured to: fuse the first result image and the second result image.

Example 22: The system of any one of examples 14 to 21, wherein the processor is further configured to: determine at least one further result image of at least one further capture area; and to fuse the first result image, the second result image, and the at least one further result image.

Example 23: The system of any one of examples 14 to 22, wherein the processor is further configured to: fuse the result images based on a determination of spatially corresponding image elements with which image element coding information is associated that specifies a predefined property in each of the result images.

Example 24: The system of any one of examples 14 to 23, provided it is in combination with example 13, wherein the processor is further configured to: fuse the result images based on a determination of spatially corresponding image elements with which image element coding information is associated that specifies a predefined property in each of the result images with the exception of spatially corresponding image elements which are determined based on the first image element of the first image with which a substitute marker is associated.

Example 25: The system of any one of examples 14 to 23, wherein the processor is further configured to: fuse the result images based on a determination of spatially corresponding image elements with which image element coding information is associated that specifies a predefined property in a predefined number of the result images.

Example 26: A system including: a processor configured to: determine a first image of a first capture area including at least one first image element associated with first image element coding information classified as erroneous; determine a second image of a second capture area, wherein the first capture area and the second capture area are at least partially overlapping in an overlap area;
determine a second image element spatially corresponding to the at least one first image element in the second image, wherein the first image element and the second image element represent at least a part of the overlap area; determine substitute image element coding information for the first image element of the first image using second image element coding information associated with the second image element of the second image that is classified as erroneous; and, based on the determined substitute image element coding information, discard the first image element coding information associated with the first image element to obtain a first substitute image.

Example 27: The system of example 26, wherein the processor is further configured to: determine the first image as a first result image, optionally by performing an outlier analysis on a further first image of the first capture area; and determine the second image as a second result image, optionally by performing an outlier analysis on a further second image of the second capture area.

Example 28: The system of example 27, wherein the processor is further configured to: determine the further first image; and/or determine the further second image.

Example 29: The system of any one of examples 27 to 28, wherein the further first image is a further first three-dimensional image optionally including distance information; and/or wherein the further second image is a further second three-dimensional image optionally including distance information.

Example 30: The system of any one of examples 27 to 29, wherein the further first image is a 3D point cloud or a depth image; and/or wherein the further second image is a 3D point cloud or a depth image.

Example 31: The system of any one of examples 27 to 30, wherein the processor is further configured to: determine the further first image of the first capture area based on image data of a first imaging device; and/or determine the further second image of the second capture area based on image data of a second imaging device.

Example 32: The system of any one of examples 26 to 31, wherein the processor is further configured to: determine the first image of the first capture area based on image data of a/the first imaging device; and/or determine the second image of the second capture area based on image data of a/the second imaging device.

Example 33: The system of any one of examples 31 to 32, which further includes: the first imaging device and/or the second imaging device.

Example 34: The system of any one of examples 31 to 33, wherein the first imaging device is a first camera, a first LiDAR camera, or a first depth camera; and/or wherein the second imaging device is a second camera, a second LiDAR camera, or a second depth camera.

Example 35: The system of any one of examples 31 to 34, wherein the processor is further configured to: determine a spatial relationship between the first imaging device and the second imaging device; and determine the second image element spatially corresponding to the at least one first image element in the second image, wherein the first image element and the second image element represent at least a part of the overlap area, using the determined spatial relationship between the first imaging device and the second imaging device.

Example 36: The system of any one of examples 26 to 35, wherein the processor is further configured to: determine the second image element corresponding to the at least one first image element in the second image, wherein the first image element and the second image element represent at least the part of the overlap area, wherein determining includes performing a coordinate transformation of the first image element from a coordinate system of the first image to a coordinate system of the second image.

Example 37: The system of example 36, wherein the processor is further configured to: determine the coordinate transformation.

Example 38: The system of any one of examples 36 to 37, provided it is in combination with example 35, wherein: performing the coordinate transformation of the first image element from the coordinate system of the first image to the coordinate system of the second image is performed using the determined spatial relationship between the first imaging device and the second imaging device.

Example 39: The system of any one of examples 26 to 38, wherein the processor is further configured to: classify the first image element coding information associated with the first image element as erroneous by determining that the first image element coding information associated with the first image element is determined based on a first origin image element of a first origin image, wherein the first origin image element corresponds spatially to the first image element, and wherein the first origin image element is associated with first origin image element coding information that is classified as erroneous; and/or classify the second image element coding information associated with the second image element as erroneous by determining that the second image element coding information associated with the second image element is determined based on a second origin image element of a second origin image, wherein the second origin image element corresponds spatially to the second image element, and wherein the second origin image element is associated with second origin image element coding information that is classified as erroneous.

Example 40: The system of example 39, wherein the processor is further configured to: classify the first origin image element coding information associated with the first origin image element as erroneous if it corresponds to a first predefined value; and/or classify the second origin image element coding information associated with the second origin image element as erroneous if it corresponds to a second predefined value.

Example 41: The system of any one of examples 39 to 40, wherein the first origin image is a first three-dimensional origin image optionally including distance information; and/or wherein the second origin image is a second three-dimensional origin image optionally including distance information.

Example 42: The system of any one of examples 39 to 41, wherein the first origin image is a 3D point cloud or a depth image; and/or wherein the second origin image is a 3D point cloud or a depth image.

Example 43: The system of any one of examples 26 to 42, wherein the processor is further configured to: fuse the first substitute image and the second image.

Example 44: The system of any one of examples 26 to 43, wherein the processor is further configured to: determine at least one further image of at least one further capture area; and fuse the first substitute image, the second image, and the at least one further image.

Example 45: The system of example 44, wherein the processor is further configured to: fuse the first substitute image, the second image, and the at least one further image based on a determination of spatially corresponding image elements with which image element coding information is associated that specifies a predefined property in a predefined number of the first substitute image, the second image, and the at least one further image.

Example 46: The system of any one of examples 44 to 45, wherein the processor is further configured to: fuse the first substitute image, the second image, and the at least one further image based on a determination of spatially corresponding image elements with which image element coding information is associated that specifies a predefined property in each of the first substitute image, the second image, and the at least one further image.

Example 47: A non-volatile computer-readable storage medium storing instructions which, when executed by a processor, cause the processor to: determine a first image of a first capture area including at least one first image element associated with first image element coding information classified as erroneous; determine a second image of a second capture area, wherein the first capture area and the second capture area are at least partially overlapping in an overlap area; determine a second image element spatially corresponding to the at least one first image element in the second image, wherein the first image element and the second image element represent at least a part of the overlap area; determine substitute image element coding information for the first image element of the first image using second image element coding information associated with the second image element of the second image that is not classified as erroneous; and associate the determined substitute image element coding information with the first image element of the first image to obtain a first substitute image.

Example 48: The non-volatile computer-readable storage medium of example 47, wherein the first image is a first three-dimensional image optionally including distance information; and/or wherein the second image is a second three-dimensional image optionally including distance information.

Example 49: The non-volatile computer-readable storage medium of any one of examples 47 to 48, wherein the first image is a 3D point cloud or a depth image; and/or wherein the second image is a 3D point cloud or a depth image.

Example 50: The non-volatile computer-readable storage medium of any one of examples 47 to 49, wherein the instructions, when they are executed by means of the processor, further cause the processor to: determine the at least one first image element of the first image as a distribution of measured values, optionally as a mean with variance or as an outlier; and/or determine the at least one second image element of the second image as a distribution of measured values, optionally as a mean with variance or as an outlier.

Example 51: The non-volatile computer-readable storage medium of any one of examples 47 to 50, wherein the instructions, when they are executed by means of the processor, further cause the processor to: determine the second image element spatially corresponding to the at least one first image element in the second image, wherein the first image element and the second image element represent at least the part of the overlap area, wherein the determining includes performing a coordinate transformation of the first image element from a coordinate system of the first image into a coordinate system of the second image.

Example 52: The non-volatile computer-readable storage medium of example 51, wherein the instructions, when they are executed by means of the processor, further cause the processor to determine the coordinate transformation.

Example 53: The non-volatile computer-readable storage medium of any one of examples 47 to 52, wherein the instructions, when they are executed by means of the processor, further cause the processor to: classify the first image element coding information associated with the first image element as erroneous if it corresponds to a predefined value.

Example 54: The non-volatile computer-readable storage medium of any one of examples 47 to 53, wherein the instructions, when they are executed by means of the processor, further cause the processor to: determine the first image of the first capture area based on image data of a first imaging device; and/or determine the second image of the second capture area based on image data of a second imaging device.

Example 55: The non-volatile computer-readable storage medium of example 54, wherein the instructions, when they are executed by means of the processor, further cause the processor to: determine a spatial relationship between the first imaging device and the second imaging device; determine the second image element spatially corresponding to the at least one first image element in the second image, wherein the first image element and the second image element represent at least a part of the overlap area, using the determined spatial relationship between the first imaging device and the second imaging device.

Example 56: The non-volatile computer-readable storage medium of example 55, wherein: performing the coordinate transformation of the first image element from the coordinate system of the first image to the coordinate system of the second image is performed using the determined spatial relationship between the first imaging device and the second imaging device.

Example 57: The non-volatile computer-readable storage medium of any one of examples 54 to 56, wherein the first imaging device is a first camera, a first LiDAR camera, or a first depth camera; and/or wherein the second imaging device is a second camera, a second LiDAR camera, or a second depth camera.

Example 58: The non-volatile computer-readable storage medium of any one of examples 47 to 57, wherein the instructions, when they are executed by means of the processor, further cause the processor to: associate with the first image element of the first image with which the substitute image element coding information is associated a substitute marker specifying that the determined substitute image element coding information is associated with the first image element of the first image.

Example 59: The non-volatile computer-readable storage medium of any one of examples 47 to 58, wherein the instructions, when they are executed by means of the processor, further cause the processor to: determine a first result image of the first capture area based on the first substitute image; and determine a second result image of the second capture area based on the second image.

Example 60: The non-volatile computer-readable storage medium of example 59, wherein the instructions, when they are executed by means of the processor, further cause the processor to: determine the first result image of the first capture area based on the first substitute image by performing an outlier analysis on a further first image of the first capture area; and determine the second result image of the second capture area based on the second image by performing an outlier analysis on a further second image of the second capture area.

Example 61: The non-volatile computer-readable storage medium of example 58 and example 59, wherein the instructions, when they are executed by means of the processor, further cause the processor to: determine the first result image of the first capture area based on the first substitute image by performing an outlier analysis on a further first image of the first capture area omitting the first image element of the first image with which the substitute marker is associated; and determine the second result image of the second capture area based on the second image by performing an outlier analysis on a further second image of the second capture area.

Example 62: The non-volatile computer-readable storage medium of any one of examples 47 to 58, wherein the instructions, when they are executed by means of the processor, further cause the processor to: determine a first result image of the first capture area by: determining substitute image element coding information based on the determined substitute image element coding information associated with the first image element of the first substitute image; updating the first substitute image by associating the determined substitute image element coding information with the first image element of the first substitute image; and determining the first result image based on the updated first substitute image, optionally by performing an outlier analysis on a further first image of the first capture area; and determine a second result image of the second capture area based on the second image, optionally by performing an outlier analysis on a further second image of the second capture area.

Example 63: The non-volatile computer-readable storage medium of any one of examples 60 to 62, wherein the instructions, when they are executed by means of the processor, further cause the processor to: determine the further first image; and/or determine the further second image.

Example 64: The non-volatile computer-readable storage medium of any one of examples 60 to 63, wherein the further first image is a further first three-dimensional image optionally including distance information; and/or wherein the further second image is a further second three-dimensional image optionally including distance information.

Example 65: The non-volatile computer-readable storage medium of any one of examples 60 to 64, wherein the further first image is a 3D point cloud or a depth image; and/or wherein the further second image is a 3D point cloud or a depth image.

Example 66: The non-volatile computer-readable storage medium of any one of examples 59 to 65, wherein the instructions, when they are executed by means of the processor, further cause the processor to: fuse the first result image and the second result image.

Example 67: The non-volatile computer-readable storage medium of any one of examples 59 to 66, wherein the instructions, when they are executed by means of the processor, further cause the processor to: determine at least one further result image of at least one further capture area; fuse the first result image, the second result image, and the at least one further result image.

Example 68: The non-volatile computer-readable storage medium of any one of examples 59 to 67, wherein the instructions, when they are executed by means of the processor, further cause the processor to: fuse the result images based on a determination of spatially corresponding image elements with which image element coding information is associated that specifies a predefined property in each of the result images.

Example 69: The non-volatile computer-readable storage medium of any one of examples 59 to 68, provided it is in combination with example 58, wherein the instructions, when they are executed by means of the processor, further cause the processor to: fuse the result images based on a determination of spatially corresponding image elements with which image element coding information is associated that specifies a predefined property in each of the result images with the exception of spatially corresponding image elements which are determined based on the first image element of the first image with which a substitute marker is associated.

Example 70: The non-volatile computer-readable storage medium of any one of examples 59 to 68, wherein the instructions, when they are executed by means of the processor, further cause the processor to: fuse the result images based on a determination of spatially corresponding image elements with which image element coding information is associated that specifies a predefined property in a predefined number of the result images.

Example 71: A non-volatile computer-readable storage medium storing instructions which, when executed by a processor, cause the processor to: determine a first image of a first capture area including at least one first image element associated with first image element coding information classified as erroneous; determine a second image of a second capture area, wherein the first capture area and the second capture area are at least partially overlapping in an overlap area; determine a second image element spatially corresponding to the at least one first image element in the second image, wherein the first image element and the second image element represent at least a part of the overlap area; determine substitute image element coding information for the first image element of the first image using second image element coding information associated with the second image element of the second image that is classified as erroneous; and, based on the determined substitute image element coding information, discard the first image element coding information associated with the first image element to obtain a first substitute image.

Example 72: The non-volatile computer-readable storage medium of example 71, wherein the instructions, when they are executed by means of the processor, further cause the processor to: determine the first image as a first result image, optionally by performing an outlier analysis on a further first image of the first capture area; and determine the second image as a second result image, optionally by performing an outlier analysis on a further second image of the second capture area.

Example 73: The non-volatile computer-readable storage medium of example 72, wherein the instructions, when they are executed by means of the processor, further cause the processor to: determine the further first image; and/or determine the further second image.

Example 74: The non-volatile computer-readable storage medium of any one of examples 72 to 73, wherein the further first image is a further first three-dimensional image optionally including distance information; and/or wherein the further second image is a further second three-dimensional image optionally including distance information.

Example 75: The non-volatile computer-readable storage medium of any one of examples 72 to 74, wherein the further first image is a 3D point cloud or a depth image; and/or wherein the further second image is a 3D point cloud or a depth image.

Example 76: The non-volatile computer-readable storage medium of any one of examples 72 to 75, wherein the instructions, when they are executed by means of the processor, further cause the processor to: determine the further first image of the first capture area based on image data of a first imaging device; and/or determine the further second image of the second capture area based on image data of a second imaging device.

Example 77: The non-volatile computer-readable storage medium of any one of examples 71 to 76, wherein the instructions, when they are executed by means of the processor, further cause the processor to: determine the first image of the first capture area based on image data of a/the first imaging device; and/or determine the second image of the second capture area based on image data of a/the second imaging device.

Example 78: The non-volatile computer-readable storage medium of any one of examples 76 to 77, wherein the first imaging device is a first camera, a first LiDAR camera, or a first depth camera; and/or wherein the second imaging device is a second camera, a second LiDAR camera, or a second depth camera.

Example 79: The non-volatile computer-readable storage medium of any one of examples 76 to 78, wherein the instructions, when they are executed by means of the processor, further cause the processor to: determine a spatial relationship between the first imaging device and the second imaging device; and determine the second image element spatially corresponding to the at least one first image element in the second image, wherein the first image element and the second image element represent at least a part of the overlap area, using the determined spatial relationship between the first imaging device and the second imaging device.

Example 80: The non-volatile computer-readable storage medium of any one of examples 71 to 79, wherein the instructions, when they are executed by means of the processor, further cause the processor to: determine the second image element spatially corresponding to the at least one first image element in the second image, wherein the first image element and the second image element represent at least the part of the overlap area, wherein the determination includes performing a coordinate transformation of the first image element from a coordinate system of the first image into a coordinate system of the second image.

Example 81: The non-volatile computer-readable storage medium of example 80, wherein the instructions, when they are executed by means of the processor, further cause the processor to determine the coordinate transformation.

Example 82: The non-volatile computer-readable storage medium of any one of examples 80 to 81, insofar as it is in combination with example 79, wherein: performing the coordinate transformation of the first image element from the coordinate system of the first image into the coordinate system of the second image is performed using the determined spatial relationship between the first imaging device and the second imaging device.

Example 83: The non-volatile computer-readable storage medium of any one of examples 71 to 82, wherein the instructions, when they are executed by means of the processor, further cause the processor to: classify the first image element coding information associated with the first image element as erroneous by determining that the first image element coding information associated with the first image element is determined based on a first origin image element of a first origin image, wherein the first origin image element corresponds spatially to the first image element, and wherein the first origin image element is associated with first origin image element coding information that is classified as erroneous; and/or classify the second image element coding information associated with the second image element as erroneous by determining that the second image element coding information associated with the second image element is determined based on a second origin image element of a second origin image, wherein the second origin image element corresponds spatially to the second image element, and wherein the second origin image element is associated with second origin image element coding information that is classified as erroneous.

Example 84: The non-volatile computer-readable storage medium of example 83, wherein the instructions, when they are executed by means of the processor, further cause the processor to: classify the first origin image element coding information associated with the first origin image element as erroneous if it corresponds to a first predefined value; and/or classify the second origin image element coding information associated with the second origin image element as erroneous if it corresponds to a second predefined value.

Example 85: The non-volatile computer-readable storage medium of any one of examples 83 to 84, wherein the first origin image is a first three-dimensional origin image optionally including distance information; and/or wherein the second origin image is a second three-dimensional origin image optionally including distance information.

Example 86: The non-volatile computer-readable storage medium of any one of examples 83 to 85, wherein the first origin image is a 3D point cloud or a depth image; and/or wherein the second origin image is a 3D point cloud or a depth image.

Example 87: The non-volatile computer-readable storage medium of any one of examples 71 to 86, wherein the instructions, when they are executed by means of the processor, further cause the processor to: fuse the first substitute image and the second image.

Example 88: The non-volatile computer-readable storage medium of any one of examples 71 to 87, wherein the instructions, when they are executed by means of the processor, further cause the processor to: determine at least one further image of at least one further capture area; and fuse the first substitute image, the second image, and the at least one further image.

Example 89: The non-volatile computer-readable storage medium of example 88, wherein the instructions, when they are executed by means of the processor, further cause the processor to: fuse the first substitute image, the second image, and the at least one further image based on a determination of spatially corresponding image elements with which image element coding information is associated that specifies a predefined property in a predefined number of the first replacement image, the second image, and the at least one further image.

Example 90: The non-volatile computer-readable storage medium of any one of examples 88 to 89, wherein the instructions, when they are executed by means of the processor, further cause the processor to: fuse the first substitute image, the second image, and the at least one further image based on a determination of spatially corresponding image elements with which image element coding information is associated that specifies a predefined property in each of the first substitute image, the second image, and the at least one further image.

Example 91: A system including: a means for determining a first image of a first capture area including at least one first image element associated with first image element coding information classified as erroneous; a means for determining a second image of a second capture area, wherein the first capture area and the second capture area are at least partially overlapping in an overlap area; a means for determining a second image element spatially corresponding to the at least one first image element in the second image, wherein the first image element and the second image element represent at least a part of the overlap area; a means for determining substitute image element coding information for the first image element of the first image using second image element coding information associated with the second image element of the second image that is not classified as erroneous; and a means for associating the determined substitute image element coding information with the first image element of the first image to obtain a first substitute image.

Example 92: The system of example 91, wherein the first image is a first three-dimensional image, optionally including distance information; and/or wherein the second image is a second three-dimensional image, optionally including distance information.

Example 93: The system of any one of examples 91 to 92, wherein the first image is a 3D point cloud or a depth image; and/or wherein the second image is a 3D point cloud or a depth image.

Example 94: The system of any one of examples 91 to 93, further including: a means for determining the at least one first image element of the first image as a distribution of measured values, optionally as a mean with variance or as an outlier; and/or a means for determining the at least one second image element of the second image as a distribution of measured values, optionally as a mean with variance or as an outlier.

Example 95: The system of any one of examples 91 to 94, further including: the means for determining the second image element spatially corresponding to the at least one first image element in the second image, wherein the first image element and the second image element represent at least the part of the overlap area, wherein the determination includes performing a coordinate transformation of the first image element from a coordinate system of the first image into a coordinate system of the second image.

Example 96: The system of example 5, further including: a means for determining the coordinate transformation.

Example 97: The system of any one of examples 91 to 96, further including: a means for classifying the first image element coding information associated with the first image element as erroneous if it corresponds to a predefined value.

Example 98: The system of any one of examples 91 to 97, further including: a means for determining the first image of the first capture area based on image data of a first imaging device; and/or a means for determining the second image of the second capture area based on image data of a second imaging device.

Example 99: The system of example 98, which further includes: the first imaging device and/or the second imaging device.

Example 100: The system of any one of examples 98 to 99, further including: a means for determining a spatial relationship between the first imaging device and the second imaging device; a means for determining the second image element spatially corresponding to the at least one first image element in the second image, wherein the first image element and the second image element represent at least a part of the overlap area, using the determined spatial relationship between the first imaging device and the second imaging device.

Example 101: The system of example 100, wherein: performing the coordinate transformation of the first image element from the coordinate system of the first image to the coordinate system of the second image is performed using the determined spatial relationship between the first imaging device and the second imaging device.

Example 102: The system of any one of examples 98 to 101, wherein the first imaging device is a first camera, a first LiDAR camera, or a first depth camera; and/or wherein the second imaging device is a second camera, a second LiDAR camera, or a second depth camera.

Example 103: The system of any one of examples 91 to 102, further including: a means for associating a substitute marker, which indicates that the determined substitute image element coding information is associated with the first image element of the first image, with the first image element of the first image with which the substitute image element coding information is associated.

Example 104: The system of any one of examples 91 to 103, further including: a means for determining a first result image of the first capture area based on the first substitute image; and a means for determining a second result image of the second capture area based on the second image.

Example 105: The system of example 104, further including: the means for determining the first result image of the first capture area based on the first substitute image by performing an outlier analysis on a further first image of the first capture area; and the means for determining the second result image of the second capture area based on the second image by performing an outlier analysis on a further second image of the second capture area.

Example 106: The system of example 103 and example 104, further including: the means for determining the first result image of the first capture area based on the first substitute image by performing an outlier analysis on a further first image of the first capture area omitting the first image element of the first image with which the substitute marker is associated; and the means for determining the second result image of the second capture area based on the second image by performing an outlier analysis on a further second image of the second capture area.

Example 107: The system of any one of examples 91 to 103, further including: a means for determining a first result image of the first capture area by: determining substitute image element coding information based on the determined substitute image element coding information associated with the first image element of the first substitute image; updating the first substitute image by associating the determined substitute image element coding information with the first image element of the first substitute image; and determining the first result image based on the updated first substitute image, optionally by performing an outlier analysis on a further first image of the first capture area; and a means for determining a second result image of the second capture area based on the second image, optionally by performing an outlier analysis on a further second image of the second capture area.

Example 108: The system of any one of examples 105 to 107, further including: a means for determining the further first image and/or a means for determining the further second image.

Example 109: The system of any one of examples 105 to 108, wherein the further first image is a further first three-dimensional image optionally including distance information; and/or wherein the further second image is a further second three-dimensional image optionally including distance information.

Example 110: The system of any one of examples 105 to 109, wherein the further first image is a 3D point cloud or a depth image; and/or wherein the further second image is a 3D point cloud or a depth image.

Example 111: The system of any one of examples 104 to 110, further including: a means for fusing the first result image and the second result image.

Example 112: The system of any one of examples 104 to 111, further including: a means for determining at least one further result image of at least one further capture area and a means for fusing the first result image, the second result image, and the at least one further result image.

Example 113: The system of any one of examples 104 to 112, further including: a means for fusing the result images based on a determination of spatially corresponding image elements with which image element coding information is associated that specifies a predefined property in each of the result images.

Example 114: The system of any one of examples 104 to 113, provided it is in combination with example 103, further including: a means for fusing the result images based on a determination of spatially corresponding image elements with which image element coding information is associated that specifies a predefined property in each of the result images with the exception of spatially corresponding image elements determined based on the first image element of the first image with which a substitute marker is associated.

Example 115: The system of any one of examples 104 to 113, further including: a means for fusing the result images based on a determination of spatially corresponding image elements with which image element coding information is associated that specifies a predefined property in a predefined number of the result images.

Example 116: A system including: a means for determining a first image of a first capture area including at least one first image element associated with first image element coding information classified as erroneous; a means for determining a second image of a second capture area, wherein the first capture area and the second capture area are at least partially overlapping in an overlap area; a means for determining a second image element spatially corresponding to the at least one first image element in the second image, wherein the first image element and the second image element represent at least a part of the overlap area; a means for determining substitute image element coding information for the first image element of the first image using second image element coding information associated with the second image element of the second image that is classified as erroneous; and a means for discarding the first image element coding information associated with the first image element based on the determined substitute image element coding information to obtain a first substitute image.

Example 117: The system of example 116, further including: a means for determining the first image as a first result image, optionally by performing an outlier analysis on a further first image of the first capture area; and a means for determining the second image as a second result image, optionally by performing an outlier analysis on a further second image of the second capture area.

Example 118: The system of example 117, further including: a means for determining the further first image; and/or a means for determining the further second image.

Example 119: The system of any one of examples 117 to 118, wherein the further first image is a further first three-dimensional image optionally including distance information; and/or wherein the further second image is a further second three-dimensional image optionally including distance information.

Example 120: The system of any one of examples 117 to 119, wherein the further first image is a 3D point cloud or a depth image; and/or wherein the further second image is a 3D point cloud or a depth image.

Example 121: The system of any one of examples 117 to 120, further including: a means for determining the further first image of the first capture area based on image data of a first imaging device; and/or a means for determining the further second image of the second capture area based on image data of a second imaging device.

Example 122: The system of any one of examples 116 to 121, further including: a means for determining the first image of the first capture area based on image data of a/the first imaging device; and/or a means for determining the second image of the second capture area based on image data of a/the second imaging device.

Example 123: The system of any one of examples 121 to 122, which further includes: the first imaging device and/or the second imaging device.

Example 124: The system of any one of examples 121 to 123, wherein the first imaging device is a first camera, a first LiDAR camera, or a first depth camera; and/or wherein the second imaging device is a second camera, a second LiDAR camera, or a second depth camera.

Example 125: The system of any one of examples 121 to 124, further including: a means for determining a spatial relationship between the first imaging device and the second imaging device; and a means for determining the second image element spatially corresponding to the at least one first image element in the second image, wherein the first image element and the second image element represent at least a part of the overlap area, using the determined spatial relationship between the first imaging device and the second imaging device.

Example 126: The system of any one of examples 116 to 125, further including: a means for determining the second image element spatially corresponding to the at least one first image element in the second image, wherein the first image element and the second image element represent at least the part of the overlap area, wherein the determination includes performing a coordinate transformation of the first image element from a coordinate system of the first image into a coordinate system of the second image.

Example 127: The system of example 126, further including: a means for determining the coordinate transformation.

Example 128: The system of any one of examples 126 to 127, provided it is in combination with example 125, wherein: performing the coordinate transformation of the first image element from the coordinate system of the first image to the coordinate system of the second image is performed using the determined spatial relationship between the first imaging device and the second imaging device.

Example 129: The system of any one of examples 116 to 128, further including: a means for classifying the first image element coding information associated with the first image element as erroneous by determining that the first image element coding information associated with the first image element is determined based on a first origin image element of a first origin image, wherein the first origin image element corresponds spatially to the first image element, and wherein the first origin image element is associated with first origin image element coding information that is classified as erroneous; and/or a means for classifying the second image element coding information associated with the second image element as erroneous by determining that the second image element coding information associated with the second image element is determined based on a second origin image element of a second origin image, wherein the second origin image element corresponds spatially to the second image element, and wherein the second origin image element is associated with second origin image element coding information that is classified as erroneous.

Example 130: The system of example 129, further including: a means for classifying the first origin image element coding information associated with the first origin image element as erroneous if it corresponds to a first predefined value; and/or a means for classifying the second origin image element coding information associated with the second origin image element as erroneous if it corresponds to a second predefined value.

Example 131: The system of any one of examples 129 to 130, wherein the first origin image is a first three-dimensional origin image optionally including distance information; and/or wherein the second origin image is a second three-dimensional origin image optionally including distance information.

Example 132: The system of any one of examples 129 to 131, wherein the first origin image is a 3D point cloud or a depth image; and/or wherein the second origin image is a 3D point cloud or a depth image.

Example 133: The system of any one of examples 116 to 132, further including: a means for fusing the first substitute image and the second image.

Example 134: The system of any one of examples 116 to 133, further including: a means for determining at least one further image of at least one further capture area; and a means for fusing the first substitute image, the second image, and the at least one further image.

Example 135: The system of example 134, further including: a means for fusing the first substitute image, the second image, and the at least one further image based on a determination of spatially corresponding image elements with which image element coding information is associated which specifies a predefined property in a predefined number of the first substitute image, the second image, and the at least one further image.

Example 136: The system of any one of examples 134 to 135, further including: a means for fusing the first substitute image, the second image, and the at least one further image based on a determination of spatially corresponding image elements with which image element coding information is associated that specifies a predefined property in each of the first substitute image, the second image, and the at least one further image.

What is claimed is:

1. A system comprising
a processor configured to:
determine a first image of a first capture area comprising at least one first image element associated with first image element coding information classified as erroneous;
determine a second image of a second capture area, wherein the first capture area and the second capture area are at least partially overlapping in an overlap area;
determine a second image element spatially corresponding to the at least one first image element in the second image, wherein the first image element and the second image element represent at least a part of the overlap area;
determine substitute image element coding information for the first image element of the first image using second image element coding information associated with the second image element of the second image that is not classified as erroneous; and
associate the determined substitute image element coding information with the first image element of the first image to obtain a first substitute image.

2. The system of claim 1, wherein the first image is a first three-dimensional image, comprising distance information; and/or wherein the second image is a second three-dimensional image, comprising distance information.

3. The system of claim 2, wherein the first image is a 3D point cloud or depth image; and/or wherein the second image is a 3D point cloud or depth image.

4. The system of claim 1, wherein the processor is further configured to associate with the first image element of the first image with which the substitute image element coding information is associated with a substitute marker indicating that the determined substitute image element coding information is associated with the first image element of the first image.

5. The system of claim 1, wherein the processor is further configured to: determine the at least one first image element of the first image as a distribution of measured values; and/or determine the second image element of the second image as a distribution of measured values.

6. The system of claim 1, wherein the processor is further configured to: determine the second image element spatially corresponding to the at least one first image element in the second image, the first image element and the second image element representing at least a portion of the overlap area, wherein the determining comprises performing a coordinate transformation of the first image element from a coordinate system of the first image to a coordinate system of the second image.

7. The system of claim 6, wherein the processor is further configured to determine the coordinate transformation.

8. The system of claim 1, wherein the processor is further configured to: classify the first image element encoding information associated with the first image element as erroneous if it corresponds to a predefined value.

9. The system of claim 1, wherein the processor is further configured to determine the first image of the first imaging area based on image data from a first imaging device; and/or determine the second image of the second imaging area based on image data from a second imaging device.

10. The system of claim 6, wherein the processor is further configured to: determine a spatial relationship between the first imaging device and the second imaging device; and determine the second image element spatially corresponding to the at least one first image element in the second image; and wherein the first image element and the second image element represent at least a portion of the overlap area using the determined spatial relationship between the first imaging device and the second imaging device.

11. The system of claim 10, wherein performing the coordinate transformation of the first image element from the coordinate system of the first image to the coordinate system of the second image is performed using the determined spatial relationship between the first imaging device and the second imaging device.

12. The system of claim 1, wherein the first imaging device is a first camera, a first LIDAR camera or a first depth camera; and/or wherein the second imaging device is a second camera, a second LiDAR camera or a second depth camera.

13. The system of claim 1, wherein the processor is further configured to: assign to the first image element of the first image to which replacement image element encoding information is assigned a replacement marker indicating that the replacement image element encoding information is assigned to the first image element of the first image.

14. The system of claim 4, wherein the processor is further configured to:
determine a first result image of the first capture area based on the first substitute image; and
determine a second result image of the second capture area based on the second image.

15. The system of claim 14, wherein the processor is further configured to:
determine the first result image of the first capture area based on the first substitute image by performing an outlier analysis on a further first image of the first capture area omitting the first image element of the first image with which the substitute marker is associated; and
determine the second result image of the second capture area based on the second image by performing an outlier analysis on a further second image of the second capture area.

16. The system of claim 14, wherein the processor is further configured to:
determine a first result image of the first capture area by:
determining substitute image element coding information based on the determined substitute image element coding information associated with the first image element of the first substitute image;
updating the first substitute image by associating the determined substitute image element coding information with the first image element of the first substitute image; and
determining the first result image based on the updated first substitute image, optionally by performing an outlier analysis on a further first image of the first capture area; and
determine a second result image of the second capture area based on the second image, optionally by performing an outlier analysis on a further second image of the second capture area.

17. A non-volatile computer-readable storage medium storing instructions which, when executed by a processor, cause the processor to:
determine a first image of a first capture area comprising at least one first image element associated with first image element coding information classified as erroneous;
determine a second image of a second capture area, wherein the first capture area and the second capture area are at least partially overlapping in an overlap area;
determine a second image element spatially corresponding to the at least one first image element in the second image, wherein the first image element and the second image element represent at least a portion of the overlap area;
determine substitute image element coding information for the first image element of the first image using second image element coding information associated with the second image element of the second image that is not classified as erroneous; and
associate the determined substitute image element coding information with the first image element of the first image to obtain a first substitute image.

18. The non-volatile computer-readable storage medium of claim 17, wherein the instructions are further configured to associate with the first image element of the first image with which the substitute image element coding information is associated with a substitute marker indicating that the determined substitute image element coding information is associated with the first image element of the first image.

19. A system comprising
a processor configured to:
determine a first image of a first capture area comprising at least one first image element associated with first image element coding information classified as erroneous;
determine a second image of a second capture area, wherein the first capture area and the second capture area are at least partially overlapping in an overlap area;
determine a second image element spatially corresponding to the at least one first image element in the second image, wherein the first image element and the second image element represent at least a portion of the overlap area;
determine substitute image element coding information for the first image element of the first image using second image element coding information associated with the second image element of the second image that is classified as erroneous; and
based on the determined substitute image element coding information, discard the first image element coding information associated with the first image element to obtain a first substitute image.

20. The system of claim 19, wherein the processor is further configured to:
classify the first image element coding information associated with the first image element as erroneous by determining that the first image element coding information associated with the first image element is determined based on a first origin image element of a first origin image, wherein the first origin image element corresponds spatially to the first image element, and wherein the first origin image element is associated with first origin image element coding information that is classified as erroneous; and/or
classify the second image element coding information associated with the second image element as erroneous by determining that the second image element coding information associated with the second image element is determined based on a second origin image element of a second origin image, wherein the second origin image element corresponds spatially to the second image element, and wherein the second origin image element is associated with second origin image element coding information that is classified as erroneous.
